(19) United States
(12) Patent Application Publication
(10) Pub. No.: US 2025/0265058 A1
(43) Pub. Date: Aug. 21, 2025

(54) COMPILER BASED DYNAMIC SCALING POWER MANAGEMENT

(71) Applicant: Google LLC, Mountain View, CA (US)

(72) Inventors: Rammohan Padmanabhan, Palo Alto, CA (US); David Alexander Majnemer, Mountain View, CA (US)

(21) Appl. No.: 18/582,503

(22) Filed: Feb. 20, 2024

(51) Int. Cl. G06F 8/41

(52) U.S. Cl. CPC G06F 8/4432

(57) ABSTRACT

Aspects of the disclosed techniques include a compilation process, e.g. for an accelerated linear algebra (XLA) compiler. The compilation process includes identifying, for each processing device of multiple processing devices in a distributed computing system, a respective portion of the uncompiled code that is to be executed by the processing device, retrieving a respective workload for each of the multiple processing devices defining an analysis of processor utilization for the respective portion of the uncompiled code that is to be executed by the processing device, and injecting a power state instruction into a respective portion of the compiled code corresponding the respective portion of the uncompiled code, that is to be executed by each of the multiple processing devices. The power state instruction identifies a voltage setting and a frequency setting that the processing device is instructed to apply when executing the respective portion of the compiled code of the computer program.

### BACKGROUND

Dynamic voltage and frequency scaling (DVFS) is a power management technique for computer processors. DVFS adapts the voltage level and clock frequency supplied to a computer processor according to the processor's current workload and other conditions. DVFS can increase or decrease the voltage supplied to a processor dependent on workload and can increase or decrease the clock speed of the processor dependent on the workload.

Distributed computing systems include multiple computing devices interconnected by a network. Distributed computing systems execute tasks across multiple processing devices. Distributed computing systems can be configured to process data in a highly parallelized and synchronous manner.

### SUMMARY

This specification describes systems, methods, devices, and related techniques for compiler-based dynamic scaling power management. The disclosed techniques can be implemented to improve power management across many processing devices in a distributed computing system.

A first aspect includes a computer implemented method. The method includes receiving uncompiled code for a computer program and compiling the uncompiled code for the computer program to generate compiled code for the computer program that is targeted for distributed execution by multiple processing devices in a distributed computing system. The compiling includes identifying, for each processing device of the multiple processing devices in the distributed computing system, a respective portion of the uncompiled code that is to be executed by the processing device, retrieving a respective workload for each of the multiple processing devices defining an analysis of processor utilization for the respective portion of the uncompiled code that is to be executed by the processing device, and injecting a power state instruction into a respective portion of the compiled code corresponding the respective portion of the uncompiled code, that is to be executed by each of the multiple processing devices. The power state instruction identifies a voltage setting and a frequency setting that the processing device is instructed to apply when executing the respective portion of the compiled code of the computer program.

A second aspect includes a system including multiple computing devices and a compiler. The compiler is configured to receive uncompiled code for a computer program, and compile the uncompiled code for the computer program to generate compiled code for the computer program that is targeted for distributed execution by the multiple computing devices. The compile includes to identify, for each computing device of the multiple computing devices, a respective portion of the uncompiled code that is to be executed by the computing device, retrieve a respective workload for each of the multiple computing devices defining an analysis of processor utilization for the respective portion of the uncompiled code that is to bed executed by the computing device, and inject a power state instruction into a respective portion of the compiled code corresponding to the respective portion of the uncompiled code, that is to be executed by each of the multiple computing devices. The power state instruction identifies a voltage setting and a frequency setting that the computing device is instructed to apply when executing the respective portion of compiled code of the computer program.

A third aspect includes a processing device of a distributed computing system. The processing device includes at least one processor and a network interface configured to electronically communicate with a centralized computing device configured to operate a compiler and manage a distributed computing system. The processing device is configured to receive compiled code for a computer program from the compiler of the distributed computing system, execute, with the at least one processor, the compiled code, and set a voltage and frequency of the at least one processor when a power state instruction is executed. The power state instruction is injected by the compiler at the centralized computing device based on a workload assigned to a portion of uncompiled code for a respective portion of the compiled code, the workload defining an analysis of processor utilization for the portion of the uncompiled code that is to be executed by the processing device.

Particular embodiments of the subject matter described in this specification can be implemented to realize one or more of the following advantages. First, reduced power consumption and improved performance can be realized by coordinating power states of processing devices executing the distributed program. Second, power consumption among processing devices executing synchronous operations in a distributed system can be reduced by coordinating power states among the multiple devices. For example, scenarios can be avoided in which a subset of processing devices are configured to operate faster (at a more expensive power state) when another slower processing device is a bottleneck for the synchronous computations. Third, reduced operating costs in a data center can be realized by adjusting power state settings for processing devices based on utility costs. Fourth, performance of large machine-learning deployments in specialized machine-learning clusters can be improved by coordinating a fleet of processing devices to execute at higher power states.

Fifth, power draw for different sections of a distributed program can be smoothed out using a power management scheme. For example, the compiler can determine ahead of time the workload for consecutive sections of the distributed program and can determine to keep power high because keeping power high in a section which would normally use low power can be beneficial when the compiler determines the program will be using high power before and/or after the section. Similarly, the compiler can determine to keep power low in a section which would normally use high power can be beneficial when the compiler determines the program will be using low power before and/or after the section.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example distributed computing system.

FIG. 2 is a flow diagram of an example process for compiling instructions with power setting instructions for execution across multiple computing devices.

FIG. 3 is a flow diagram of an example process for training a cost model used for injecting power setting instructions into a set of instructions for execution across multiple computing devices.

FIG. 4 is a flow diagram of an example process for executing instructions with power setting instructions at a processing device in a distributed computing system.

Like reference numbers and designations in the various drawings indicate like elements.

### DETAILED DESCRIPTION

This specification describes systems, methods, devices, and techniques for implementing compiler-based dynamic scaling power management. In some implementations, the compiler is an accelerated linear algebra (XLA) compiler and the techniques are implemented to improve power management across a fleet of processing devices in a distributed computing system.

In general, the compiler detects a workload that is set or otherwise anticipated to be processed by a program in a distributed computing system. Based on characteristics of the workload, the compiler injects power state instructions into code that it compiles for a program that will process the workload. Each processing device that executes the power state instruction injected in the compiled code can set its power state according to the instruction. The power state instruction can indicate a target frequency setting (e.g., clock frequency) for the processing device executing the compiled code, a voltage setting for the processing device executing the compiled code, or both. In some implementations, the compiler analyzes High-Level Operations (HLOs) to determine the workload of a program.

Example implementations include a method for improving the performance and reducing power consumption of processing devices in a data center. The compiler, which is aware of the workload and HLOs to be performed by the processing devices, controls the power settings for the processing devices on which the instructions are to execute.

Through injection of power state instructions in code sent to each of multiple processing devices in a distributed system, the compiler can effectively cause a fleet of processing devices to increase or decrease their respective voltage levels and frequencies in a coordinated, synchronous manner. Higher voltages and frequencies allow HLO operations to be executed more quickly and in less time. Lower voltages and frequencies, by contrast, can be set to conserve power.

In some examples, the techniques disclosed herein are applied to compile and execute a program for training or using a machine-learning model. In some examples, the machine-learning model may be a large language model (LLM), the training of which requires coordination over a large number of processing devices. The techniques can be used to improve performance and/or reduce power consumption of training large language models by coordinating the power settings for the large number of processing units. The systems and methods can also be used with other generative AI models.

In conventional machine-learning model training scenarios, performance is often limited by the slowest processing device. Therefore, increasing the speed of other processing devices does not yield any performance benefits. By synchronizing a set of processing devices to operate faster simultaneously, the overall performance can be enhanced. Similarly, by synchronizing the entire set of processing devices to operate slower, significant power savings can be achieved with little to no sacrifice in performance. In some implementations, this concept can be further combined with utility kilowatt/hour pricing (day vs night time pricing) to reduce operational expenses for the data center. This results in performance benefits and/or a reduction in energy usage for large scale deployments in a data center.

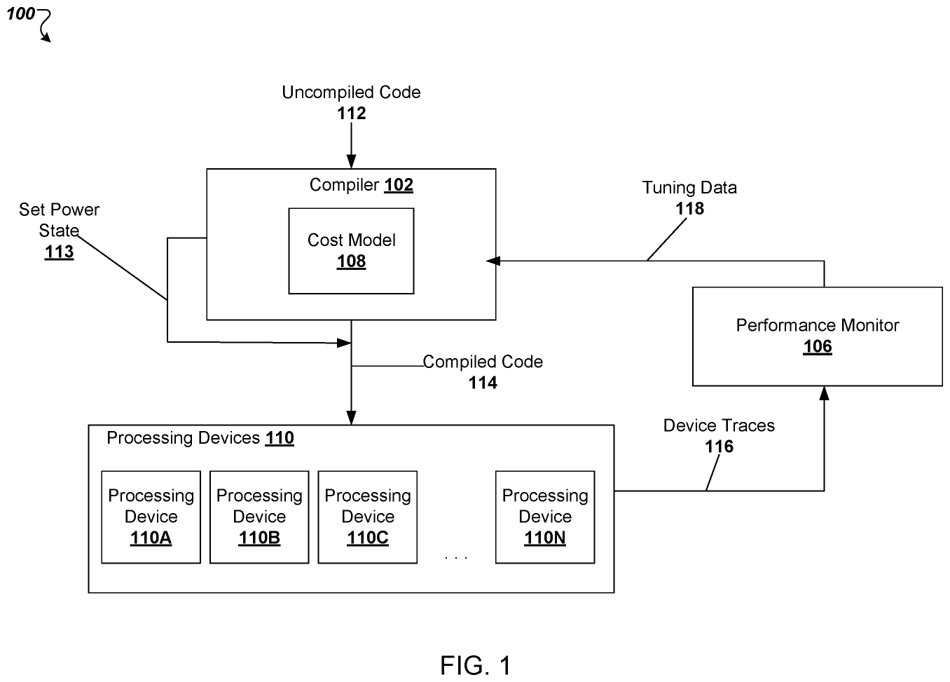

FIG. 1 illustrates an example distributed computing system 100. The distributed computing system 100 includes a compiler 102, processing devices 110 (110A-110N), and a performance monitor 106.

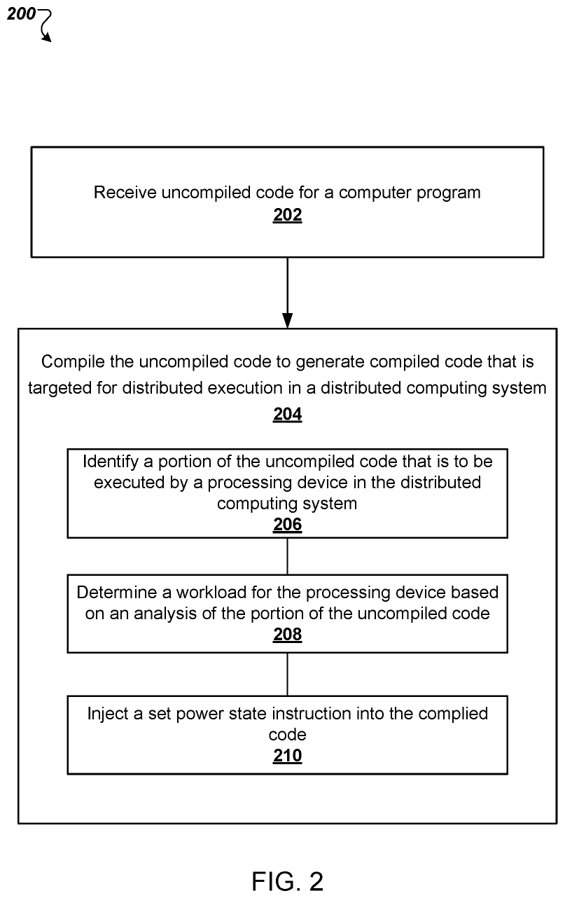

The compiler 102 is configured to compile a program to be executed by the processing devices 110. In the example shown, the compiler 102 receives instructions from uncompiled code 112 of a computer program and generates compiled code 114 that is targeted for execution across the distributed processing devices 110. The compiler 102 is configured to control the power state of the processing devices 110 by injecting a power state instruction 113 into the compiled code 114. For example, the compiler 102 can coordinate the dynamic power characteristics of the processing devices 110 as they execute respective portions of the distributed program by injecting power state instructions 113 in the compiled code 114 that direct and cause the processing devices 110 to move to a higher voltage and/or a higher frequency to execute the compiled code 114 faster or move to lower voltage and/or a lower frequency to reduce power consumption. An example process for compiling instructions with power setting instructions for execution across multiple computing devices is illustrated and described in reference to FIG. 2.

In some implementations, the compiler 102 injects power state instructions 113 into the compiled code 114. Each power state instruction 113 identifies a voltage setting, a frequency setting, or both, for a processing device. The processing devices 110 respond to the power state instructions 113 by adjusting their power settings as indicated by the instructions. In some examples, the power state is encoded in an instruction that is specific to the architecture of the processing devices 110.

In some implementations, the compiler 102 is an accelerated linear algebra (XLA) compiler or other compiler that performs compilation of computer programs representing a machine-learning model (e.g., a computational graph for a neural network) or a portion of a machine-learning model (e.g., a subgraph corresponding to a subset of nodes in a neural network). In some of these examples, the compiled code includes high level operations (HLO) for a computational graph defining a machine-learning model (e.g., a deep neural network or a large language model). In some of these examples, the compiler outputs compiled code in an instruction set specific to the hardware of the particular processing devices 110. Examples of an XLA compiler are illustrated and described in U.S. patent application Ser. No. 18/482,738, entitled “DEPLOYING OPTIMIZATION PROFILES FOR COMPILING COMPUTER PROGRAMS IN DATA CENTERS”, and filed on Oct. 6, 2023, the entire contents of which are hereby incorporated by reference.

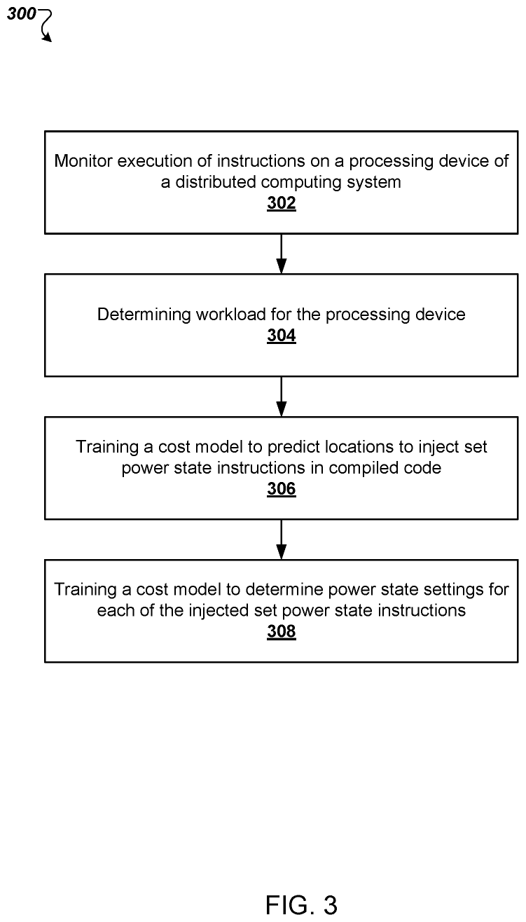

In the implementation shown, the compiler 102 includes or references a cost model 108. The cost model 108 is configured to determine where to inject power state instructions and what adjustments to the power settings should be set by the power state instructions. In some examples, the cost model 108 processes the operations assigned to a processing device to determine a workload for the device and based on this workload determine a power setting for the processing device. An example method for training the cost model 108 is illustrated and described in reference to FIG. 3.

In some examples, the cost model 108 is used to identify high level operations that are candidates to run at a higher or lower power state. In some implementations, the cost model 108 receives adjustment criteria for a program. For example, some programs may set the adjustment criteria to make power state changes that reduce energy consumption to reduce energy costs while others may request to make adjustments to improve performance. The adjustment criteria may define criteria with combinations of adjustment to reduce energy consumption and adjustments to improve performance. In some examples, the adjustment criteria for a program may include a budget. In some implementations, the cost model 108 receives feedback indicating that one or more of the processors were throttled for going over a power/limit budget. This feedback can be used by the cost model 108 to improve the adjustment criteria for subsequent compilations of programs. In some implementations, the cost model 108 may also receive current utility prices as an input and determine locations within the code and setting adjustments for the power state instructions 113 based at least in part on current utility prices. For example, when programs are executed during peak energy cost periods the cost model 108 may automatically determine to adjust the power settings to reduce power usage and when the program is executed at low energy cost periods the cost model may adjust to improve performance. In some examples, the cost model is used to smooth power draw for different sections of a distributed program. For example, the cost model can determine ahead of time the workload for consecutive sections of the distributed program and can keep the power state high because keeping the power state high in a section which would normally use a low power state can smooth the power draw when the compiler determines the program will be using a high power state before and/or after the section. Similarly, the cost model can determine to keep the power state low in a section which would normally use a high power state to smooth the power draw when the compiler determines the program will be using a low power state before and/or after the section.

In some examples, the compiled code being executed across the processing devices 110 are substantially similar (e.g., the processing of highly parallel data) and the cost model 108 can process the instructions for one of a single processing devices (or a subset of processing device) and apply consistent power settings across the processing devices.

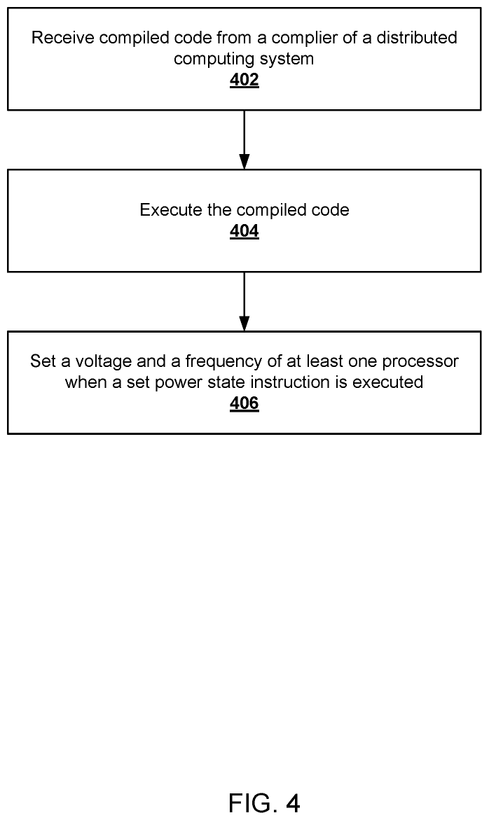

The processing devices 110 includes multiple processing devices 110A-N. The processing devices 110A-N can include central processing units including specialized units for machine-learning models and or specialized units for processing highly parallel data, such as a graphics processing unit (GPU). In some implementations, the processing devices 110A-N are machine learning and/or artificial intelligence accelerator application-specific integrated circuit, for example, Tensor Processing Units (TPUs) or GPUs. The processing devices 110A-N are networked together to coordinate the processing of jobs across the processing devices 110A-N. An example process executed by one of the processing devices 110A-N for executing instructions with power setting instructions is illustrated and described in reference to FIG. 4.

Each of the processing devices 110 are configured to adjust a power setting of the processing device when a power state instruction 113 is executed. In some implementations, the power state instruction 113 is an instruction included in the instruction architecture of the processing devices 110.

In some examples, a collection of processing devices 110 are referred to as a slice or pod. For example, a slice or pod may refer to a collection of processing devices 110 that are collectively training a given machine-learning model. In these examples, the compiler 102 is configured to be aware of the workload across processing devices 110 in the slice or pod and can perform dynamic voltage and frequency scaling across the processing devices in the slice or pod.

The performance monitor 106 monitors the performance of one or more of the processing devices 110. In some examples, the performance monitor 106 receives device traces 116 from one or more of the processing devices 110A-N. A device trace 116 includes data related to a workload of a given set of instructions executed at a device. Examples of data included in a device trace 116 include floating-point operations per second (FLOP) utilization and memory bandwidth utilization.

In some examples, the device trace 116 includes the high-level operations executed by the processing device with the workload required for the high level workload (e.g., FLOP utilization and memory bandwidth utilization for the high level operation). In some examples, a device trace 116 includes data on whether the processing device had to throttle the power settings (e.g., a processing device may automatically adjust the power settings to avoid overheating). The device traces 116 can be provided as tuning data 118 to the cost model 108 to train and/or tune the cost model to determine what power setting to apply for different high level operations. In some implementations, example programs are monitored by the performance monitor 106 and the cost model is tuned offline using the data collected from multiple example programs.

In some implementations, the distributed computing system 100 is used with a variety of machine-learning models. In some examples, processes related to the machine-learning models require processing of highly parallel data, where the processing of the highly parallel data must be in a synchronized manner. For example, a machine-learning model may be trained more efficiently and/or effectively using a distributed computing system that allows for synchronous training. In these examples, the compiler 102 can be configured to coordinate the power state across the multiple distributed processing devices 110 to improve performance and/or reduce power usage. In some cases, performance for training a machine-learning model may be limited by the slow instance of one of the processing devices 110. For example, if the processing device 110A is slower than the other processing devices 110B-N there is limited benefit in performance by running any of the other processing devices 110B-N faster (e.g., the power settings for any of the processing devices 110B-N at a higher voltage and/or frequency). To avoid wasting resources when executing a highly synchronized program (e.g., a program training a machine-learning model) the compiler 102 can orchestrate all of the processing devices 110A-N to operate faster simultaneously by injecting power state instructions 113 that define a power setting with a higher voltage and/or a higher frequency. Similarly, the compiler 102 can orchestrate all of the processing devices 110A-N to go slower simultaneously to reduce power consumption by injecting power state instructions 113 that define a power setting with a lower voltage and/or a lower frequency.

In some examples, the systems and methods disclosed herein are used to compile and execute a program for training or using a machine-learning model. In some examples, the machine-learning model may be a large language model (LLM), the training of which requires coordination over a large number of processing units. In these examples, the workload aware compiler is able to adjust for improved performance and/or reduced power consumption across the large number of processing units required to train the LLM.

FIG. 2 is a flow diagram of an example process 200 for compiling instructions with power setting instructions for execution across multiple computing devices. In some examples, the process 200 is performed by the compiler 102, illustrated and described in reference to FIG. 1. The example process 200 includes the operations 202 and 204. The operation 204 includes sub-operations 206 and 208.

At the operation 202, the compiler receives uncompiled code for a computer program. In some examples, the computer program is targeted to be executed by a distributed computing system (for example, the distributed computing system 100 illustrated and described in reference to FIG. 1). In some examples, the uncompiled may include operations for training a machine-learning model. In some examples, the uncompiled code includes high level operations that are compiled to execute across multiple processing devices at the operation 204.

At the operation 204, the compiler compiles the uncompiled code to generate compiled code. The compiled code is targeted for distributed execution in a distributed computing system having multiple processing devices. In the example shown in FIG. 1, the operation 204 is performed by the compiler 102. The operation 204 includes the sub-operations 206 and 208.

At the sub-operation 206, the compiler identifies a portion of the uncompiled code that is to be executed by a processing device in the computing system. In some implementations, the portion of uncompiled code includes high level operations.

At the sub-operation 208, the compiler determines a workload for the processing device based on an analysis for the portion of the uncompiled code. In some examples, the compiler determines a workload for one or more processing devices of the multiple processing devices based on one or more subsets of computer code set to be executed by the one or more processing devices. In some implementations, high level operations are identified and an associated workload is retrieved from a database. For example, an associated workload for a high level operation can be retrieved from a database storing monitored data for the high level operations. In some of these examples, the performance monitor 106 described in FIG. 1 monitors and stores workloads in the database, where the workloads are observed from the execution of specific high level operations. In some implementations, determining the workload for a device in the one or more devices includes calculating a workload for the device by identifying one or more operations in the computer code set for execution by the device and retrieving the workload associated with each of the identified one or more operations. In some implementations, the workload for the operation is updated dynamically based on the monitoring of the execution of operation on one or more of the processing devices.

In some implementations, the compiler uses a cost model to determine a workload for the one or more subsets of computer code. The cost model is trained (offline and/or in real time) by monitoring execution of operations on a processing device and determining the workload for the operation based on the monitoring of the execution of the operation. In some implementations, the cost model is configured to predict locations in the instructions to inject power state instructions and predict a voltage setting and a frequency setting for each of the power state instructions. An example process 300 for training a cost model is illustrated and described in reference to FIG. 3.

At the sub-operation 210, the compiler injects a power state instruction into the compiled code. In some examples, the sub-operation 210 includes injecting at least one power state instruction into one or more subsets of computer code based on the workload for the one or more processing devices. The power state instruction sets a voltage setting and a frequency setting of a processor executing the power state instruction. In some examples, the multiple power state instructions are injected into the one or more subsets of instructions and are compiled to execute across the one or more of processing devices in parallel.

FIG. 3 is a flow diagram of an example process 300 for training a cost model used for injecting power setting instructions into a set of instructions for execution across multiple computing devices. In some example implementations, the cost model is trained using example device traces data before deploying the cost model with a compiler. In some implementations, the cost model is continuously trained and updated. The process 300 includes the operations 302, 304, 306, and 308.

At the operation 302, the performance monitor monitors execution of instructions on one or more processing devices of a distributed computing system. For example, by the performance monitor 106 in the distributed computing system 100 illustrated and described in reference to FIG. 1. In some examples, device traces from one or more processing devices are received. The device traces include data related to a workload for a processing device, the operations executed, and the power settings for the processing devices. For example, the traces may define a FLOPs utilization and memory utilization of a processing device when executing a high level operation.

At the operation 304, the performance monitor determines a workload for the one or more processing devices executing the instructions. In some implementations, the workload is defined by floating-point operations per second (FLOP) utilization and/or memory bandwidth utilization. In some examples, the device traces are processed to determine the workload for high level operations are determined. In some examples, FLOP utilization is used to determine how bound to a processing core an operation is. For example, a flop utilization of 1 (e.g., 100%) is indicative of the entire workload being bound to the processing core and a flop utilization of 0 (e.g., 0%) is indicative of none of the work being bound to the core. Processing the device traces allows the cost model to be trained on a workload observed of operations running on the processing devices.

The operation 306, the performance monitor (or a training module) trains a cost model to predict locations to inject power state instructions in the instructions. In some examples, the workload determined at the operation 304 is analyzed to determine locations to inject power state instructions. For example, a power state instruction which increases the speed of the processing unit (for example, by increasing the voltage and/or frequency) can be injected before a high level operation which is determined to have a high workload. The operation 306 can also train the model to predict opportunities to lower the power usage based on the analysis of the workload for the high level operations.

In some implementations, the cost model is trained to identify high level operations which are likely to require an adjustment to the power settings. The high level operations include a set of instructions that are grouped for performing the high level operation. In some examples, determining a workload for a high level operation includes taking an average of the instructions in the set of instructions grouped for performing the high level operation.

At the operation 308, the performance monitor (or a training module) trains a cost model to predict power state settings for each of the injected power state instructions. The performance monitor (or the training module) determines power state settings for each of the injected power state instructions. In some examples, the cost model can include other inputs which are processed alongside the determined workload to predict power state settings for each of the injected power state instructions. For example, the cost model may consider adjustment criteria (e.g., criteria to aggressively adjust the power settings to improve performance, criteria to moderately adjust for performance, criteria to moderately adjust for reducing power consumption, and criteria to aggressively adjust for power consumption. Additionally, example inputs that can be considered by the cost model include indications of whether any of the processing devices are being throttled, utility costs, an assigned budget for a project, etc. In some examples, the cost model also considers a global policy set by a provider of the distributed computing system.

In some examples, the operation 306 and 308 occur concurrently. In other examples, the operation 306 first determines where to inject power state instructions and then the operation 308 determines power settings for each of the injected power state instructions.

FIG. 4 is a flow diagram of an example process 400 for executing instructions with power setting instructions at a processing device in a distributed computing system. In some examples, the process 400 is executed by one or more of the processing device 110 as illustrated and described in reference to FIG. 1. The process 400 includes the operations 402, 404, and 406.

At the operation 402, the processing device receives compiled instructions from a compiler of a distributed computing system. In the example shown in FIG. 1, the compiler 102 compiles instructions which are assigned and sent to the processing devices 110.

At the operation 404, the processing device executes the compiled instructions. In the example shown in FIG. 1, each of the processing devices 110 execute the compiled instructions received from the compiler 102.

At the operation 406, the processing device sets a voltage and a frequency of at least one processor when a power state instruction is executed. In some implementations, the power state instruction is injected by the compiler based on a forecasted workload for the computing device. In the example shown in FIG. 1, each of the processing devices 110A-N are designed to adjust power settings when a power state instruction is executed. In some examples, the power state instruction sets a voltage and a frequency for the processing device. In some implementations the power state instruction is injected by the compiler at the centralized computing device based on a workload assigned to a portion of uncompiled code for a respective portion of the compiled code, the workload defining an analysis of processor utilization for the portion of the uncompiled code that is to be executed by the processing device.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine-learning models can also include, for example, special-purpose hardware accelerator units for processing common and compute-intensive parts of machine learning training or production, i.e., inference, workloads.

Machine-learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments of the attached claims and the embodiments described above, the following numbered embodiments are also innovative:

Embodiment 1 is a computer-implemented method. The method includes receiving uncompiled code for a computer program; and compiling the uncompiled code for the computer program to generate compiled code for the computer program that is targeted for distributed execution by multiple processing devices in a distributed computing system. The compiling includes identifying, for each processing device of the multiple processing devices in the distributed computing system, a respective portion of the uncompiled code that is to be executed by the processing device, retrieving a respective workload for each of the multiple processing devices defining an analysis of processor utilization for the respective portion of the uncompiled code that is to be executed by the processing device, and injecting a power state instruction into a respective portion of the compiled code corresponding the respective portion of the uncompiled code, that is to be executed by each of the multiple processing devices, where the power state instruction identifies a voltage setting and a frequency setting that the processing device is instructed to apply when executing the respective portion of the compiled code of the computer program.

Embodiment 2 is the computer-implemented of embodiment 1 where a first processing device and a second processing device of the multiple processing devices are targeted to execute different portions of the compiled code with a same voltage setting and a same frequency setting according to the power state instruction.

Embodiment 3 is the computer-implemented of embodiment 1, where a first processing device and a second processing device of the multiple processing devices are targeted to execute different portions of the compiled code with different voltage and frequency settings according to the power state instruction.

Embodiment 4 is the computer-implemented of any of embodiments 1-3, where the uncompiled code defines high level operations for a computational graph defining a machine-learning model.

Embodiment 5 is the computer-implemented of any of embodiments 1-4, where the compiling is performed by an accelerated linear algebra (XLA) compiler.

Embodiment 6 is the computer-implemented method of any of embodiments 1-5, where multiple power state instructions are injected into the compiled code for execution by the multiple processing devices in parallel.

Embodiment 7 is the computer-implemented method of any of embodiments 1-6, where a workload is defined for high level operations included in the uncompiled code.

Embodiment 8 is the computer-implemented method of embodiment 7, where retrieving the respective workload for each of the multiple processing devices includes calculating the respective workload for a processing device by identifying one or more operations in the respective portion of uncompiled code set for execution by the processing device and retrieving a workload associated with each of the identified one or more operations.

Embodiment 9 is the computer-implemented method of embodiment 7 or 8, where the one or more operations are high level operations for training a machine-learning model.

Embodiment 10 is the computer-implemented method of any of embodiments 7-9, further including monitoring an execution of an operation on a processing device of the multiple processing devices and determining the workload for the operation based on the monitoring of the execution of the operation.

Embodiment 11 is the computer-implemented method of embodiment 10, where the workload for the operation is updated dynamically based on the monitoring of the execution of operation on the processing device.

Embodiment 12 is the computer-implemented method of any of embodiments 1-11, where injecting the power state instruction into the compiled code is further based on a cost model.

Embodiment 13 is the computer-implemented method of embodiment 12, where the cost model is configured to predict locations in the compiled code to inject power state instructions and predict a voltage setting and a frequency setting for each of the power state instructions.

Embodiment 14 is the computer-implemented method of embodiment 13, where the cost model is trained using monitored device traces of a processing device executing high level operations.

Embodiment 15 is the computer-implemented method of any of embodiments 12-14, where predictions made by the cost model are further based at least in part on utility costs.

Embodiment 16 is the computer-implemented method of any of embodiments 12-15, where the workload is defined by at least one of the following: (a) floating-point operations per second (FLOP) utilization, and (b) memory bandwidth utilization.

Embodiment 17 is the computer-implemented method of any of embodiments 1-16, where the computer program is for training a machine-learning model.

Embodiment 18 is the computer-implemented method of embodiment 17, where the machine-learning model is a large language model.

Embodiment 19 is a system. The system includes multiple computing devices and a compiler. The compiler is configured to receive uncompiled code for a computer program and compile the uncompiled code for the computer program to generate compiled code for the computer program that is targeted for distributed execution by the multiple computing devices. Where the compile includes to identify, for each computing device of the multiple computing devices, a respective portion of the uncompiled code that is to be executed by the computing device, retrieve a respective workload for each of the multiple computing devices defining an analysis of processor utilization for the respective portion of the uncompiled code that is to bed executed by the computing device, and (iii) inject a power state instruction into a respective portion of the compiled code corresponding to the respective portion of the uncompiled code, that is to be executed by each of the multiple computing devices, where the power state instruction identifies a voltage setting and a frequency setting that the computing device is instructed to apply when executing the respective portion of compiled code of the computer program.

Embodiment 20 is the system of embodiment 19, where at least some of the compiled code is targeted to execute synchronously across the multiple computing devices, and the compiler sets the voltage setting and power setting in the power state instruction according to a sampled workload of the multiple computing devices.

Embodiment 21 is the system of embodiment 19 or 20, where the compiler coordinates injection of multiple power state instructions into the compiled code for execution across the multiple computing devices to improve performance and reduce energy usage.

Embodiment 22 is the system of any of embodiments 19-21, where the compiler is configured to inject power state instructions that increase a voltage and a frequency of one or more computing devices of the multiple computing devices to improve performance.

Embodiment 22 is the system of any of embodiments 19-21, where the compiler is configured to inject power state instructions that lower a voltage and a frequency of one or more computing devices of the multiple computing devices to reduce power consumption.

Embodiment 23 is a processing device of a distributed computing system. The processing devices includes at least one processor and a network interface configured to electronically communicate with a centralized computing device configured to operate a compiler and manage a distributed computing system. Where the processing device is configured to receive compiled code for a computer program from the compiler of the distributed computing system, execute, with the at least one processor; the compiled code, and set a voltage and frequency of the at least one processor when a power state instruction is executed. Where the power state instruction is injected by the compiler at the centralized computing device based on a workload assigned to a portion of uncompiled code for a respective portion of the compiled code, the workload defining an analysis of processor utilization for the portion of the uncompiled code that is to be executed by the processing device.

Embodiment 24 is the processing device of embodiment 23, where the processing device is a tensor processing unit.

Embodiment 25 is the processing device of embodiment 23 or 24, where the compiler is an XLA compiler.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method, comprising:
receiving uncompiled code for a computer program; and
compiling the uncompiled code for the computer program to generate compiled code for the computer program that is targeted for distributed execution by a plurality of processing devices in a distributed computing system, wherein the compiling includes:
(i) identifying, for each processing device of the plurality of processing devices in the distributed computing system, a respective portion of the uncompiled code that is to be executed by the processing device;
(ii) retrieving a respective workload for each of the plurality of processing devices defining an analysis of processor utilization for the respective portion of the uncompiled code that is to be executed by the processing device; and
(iii) injecting a power state instruction into a respective portion of the compiled code corresponding the respective portion of the uncompiled code, that is to be executed by each of the plurality of processing devices, wherein the power state instruction identifies a voltage setting and a frequency setting that the processing device is instructed to apply when executing the respective portion of the compiled code of the computer program.

2. The computer-implemented method of claim 1, wherein a first processing device and a second processing device of the plurality of processing devices are targeted to execute different portions of the compiled code with a same voltage setting and a same frequency setting according to the power state instruction.

3. The computer-implemented method of claim 1, wherein a first processing device and a second processing device of the plurality of processing devices are targeted to execute different portions of the compiled code with different voltage and frequency settings according to the power state instruction.

4. The computer-implemented method of claim 1, wherein the uncompiled code defines high level operations for a computational graph defining a machine-learning model.

5. The method of claim 1, wherein the compiling is performed by an accelerated linear algebra (XLA) compiler.

6. The computer-implemented method of claim 1, wherein a plurality of power state instructions are injected into the compiled code for execution by the plurality of processing devices in parallel.

7. The computer-implemented method of claim 1, wherein a workload is defined for high level operations included in the uncompiled code.

8. The computer-implemented method of claim 7, wherein retrieving the respective workload for each of the plurality of processing devices includes:
calculating the respective workload for a processing device by identifying one or more operations in the respective portion of uncompiled code set for execution by the processing device and retrieving a workload associated with each of the identified one or more operations.

9. The computer-implemented method of claim 7, wherein the one or more operations are high level operations for training a machine-learning model.

10. The computer-implemented method of claim 7, further comprising:
monitoring an execution of an operation on a processing device of the plurality of processing devices; and
determining the workload for the operation based on the monitoring of the execution of the operation.

11. The computer-implemented method of claim 10, wherein the workload for the operation is updated dynamically based on the monitoring of the execution of operation on the processing device.

12. The computer-implemented method of claim 1, wherein injecting the power state instruction into the compiled code is further based on a cost model.

13. The computer-implemented method of claim 12, wherein the cost model is configured to:
predict locations in the compiled code to inject power state instructions; and
predict a voltage setting and a frequency setting for each of the power state instructions.

14. The computer-implemented method of claim 13, wherein the cost model is trained using monitored device traces of a processing device executing high level operations.

15. The computer-implemented method of claim 12, wherein predictions made by the cost model are further based at least in part on utility costs.

16. The computer-implemented method of claim 12, wherein the workload is defined by at least one of:
(a) floating-point operations per second (FLOP) utilization;
(b) memory bandwidth utilization; or
(c) any combination of (a) and (b).

17. The computer-implemented method of claim 1, wherein the computer program is for training a machine-learning model.

18. The computer-implemented method of claim 17, wherein the machine-learning model is a large language model.

19. A system comprising:
a plurality of computing devices; and
a compiler configured to:
receive uncompiled code for a computer program; and
compile the uncompiled code for the computer program to generate compiled code for the computer program that is targeted for distributed execution by the plurality of computing devices, wherein the compile includes to:
(i) identify, for each computing device of the plurality of computing devices, a respective portion of the uncompiled code that is to be executed by the computing device;
(ii) retrieve a respective workload for each of the plurality of computing devices defining an analysis of processor utilization for the respective portion of the uncompiled code that is to bed executed by the computing device; and
(iii) inject a power state instruction into a respective portion of the compiled code corresponding to the respective portion of the uncompiled code, that is to be executed by each of the plurality of computing devices, wherein the power state instruction identifies a voltage setting and a frequency setting that the computing device is instructed to apply when executing the respective portion of compiled code of the computer program.

20. The system of claim 19, wherein at least some of the compiled code is targeted to execute synchronously across the plurality of computing devices, and the compiler sets the voltage setting and power setting in the power state instruction according to a sampled workload of the plurality of computing devices.

21. The system of claim 19, wherein the compiler coordinates injection of a plurality of power state instructions into the compiled code for execution across the plurality of computing devices to improve performance and reduce energy usage.

22. The system of claim 19, wherein the compiler is configured to:
inject power state instructions that increase a voltage and a frequency of one or more computing devices of the plurality of computing devices to improve performance.

23. The system of claim 19, wherein the compiler is configured to:
inject power state instructions that lower a voltage and a frequency of one or more computing devices of the plurality of computing devices to reduce power consumption.

24. A processing device of a distributed computing system comprising:
at least one processor; and
a network interface configured to electronically communicate with a centralized computing device configured to operate a compiler and manage a distributed computing system;
wherein the processing device is configured to:
receive compiled code for a computer program from the compiler of the distributed computing system;
execute, with the at least one processor, the compiled code; and
set a voltage and frequency of the at least one processor when a power state instruction is executed,
wherein the power state instruction is injected by the compiler at the centralized computing device based on a workload assigned to a portion of uncompiled code for a respective portion of the compiled code, the workload defining an analysis of processor utilization for the portion of the uncompiled code that is to be executed by the processing device.
